(19) United States
(12) Patent Application Publication
(10) Pub. No.: US 2026/0213093 A1
(43) Pub. Date: Jul. 23, 2026

(54) INPUT DEVICE

(71) Applicant: Alps Alpine Co., Ltd., Tokyo (JP)

(72) Inventors: Tomoaki TSUCHIYA, Miyagi-ken (JP); Takuya ISHIKAWA, Miyagi-ken (JP); Misa YODA, Miyagi-ken (JP)

(21) Appl. No.: 19/443,331

(22) Filed: Jan. 8, 2026

(30) Foreign Application Priority Data
Jan. 17, 2025 (JP) 2025-007153

(51) Int. Cl. H01H 13/14; H01H 13/04; H01H 13/10; H01H 13/70; H01H 13/79

(52) U.S. Cl. CPC H01H 13/14; H01H 13/04; H01H 13/10; H01H 13/7006; H01H 13/79; H01H 2231/026

(57) ABSTRACT

An input device includes a knob, a substrate, a pressing switch, a sheet-like rubber member, and an actuator member sliding in a direction perpendicular to the substrate, a pre-tension being applied between the knob, the actuator member, and the pressing switch in a neutral state, the pressing switch has a first contact portion that contacts the rubber member and includes a metal restoring member that has elasticity and biases the first contact portion against the rubber member, and the actuator member has a second contact portion that contacts the rubber member, the second contact portion facing the first contact portion with the rubber member interposed therebetween, and has a protrusion that extends from the second contact portion toward the rubber member and presses and elastically deforms the rubber member in the neutral state in which the knob is released from the operating force applied to the knob.

### CLAIM OF PRIORITY

This application claims benefit of Japanese Patent Application No. 2025-007153 filed on January 17, 2025, which is hereby incorporated by reference.

### BACKGROUND OF THE INVENTION

### Field of the Invention

The present invention relates to an input device.

### Description of the Related Art

International Publication No. 2007/097107 discloses a seesaw-type switch device including an operation button and two switches, wherein a pre-tension is applied between the operating button and the switches using the restoring force from the switches.

The seesaw-type switch device disclosed in International Publication No. 2007/097107 discloses a configuration that applies a pre-tension from the switch to the seesaw-type operation button, and is configured to utilize the restoring force that returns the switch distal end portion from the depressed state to the initial state as a resource. Therefore, in a case where the switch stroke is small, for example, in a case of using a metal dome switch, the stroke is typically around 1 millimeter (1 mM), and in a case of using components with variations in the length dimension of the pressing portion that contacts the switch or the component dimensions specifying the height position of the switch, a gap is formed between the switch and the component depending on a combination of components, so that the pre-tension may not be applied as expected.

### SUMMARY OF THE INVENTION

An input device according to an embodiment includes a knob that receives an operating force from an operator and transitions by the operating force, a substrate, a pressing switch provided on one side of the substrate, a sheet-like rubber member covering the substrate and the pressing switch, and an actuator member provided between the knob and the rubber member and sliding in a direction perpendicular to the substrate in response to the transition of the knob, a pre-tension being applied between the knob, the actuator member, and the pressing switch in a neutral state in which the knob is released from the operating force, wherein the pressing switch has a first contact portion with a planar shape that contacts the rubber member and includes a metal restoring member that has elasticity and biases the first contact portion against the rubber member, and wherein the actuator member has a second contact portion with a planar shape that contacts the rubber member, the second contact portion being disposed facing the first contact portion of the pressing switch with the rubber member interposed between the second contact portion and the first contact portion, and has a protrusion that extends from the second contact portion toward the rubber member and presses and elastically deforms the rubber member in the neutral state in which the knob is released from the operating force applied to the knob.

According to an input device according to an embodiment, it is possible to provide a pre-tension configuration that is less susceptible to the effects of component dimensional variation and does not significantly increase cost.

### BRIEF DESCRIPTION OF THE DRAWINGS

FIG. 1 is an appearance perspective view of the input device according to an embodiment;

FIG. 2 is a plan view of the input device according to an embodiment;

FIG. 3 is a left side view of the input device according to an embodiment;

FIG. 4 is a cross-sectional view of the input device according to an embodiment, taken along IV-IV section line shown in FIG. 2;

FIG. 5 is a partial enlarged view of the cross-sectional view shown in FIG. 4;

FIG. 6 is an exploded perspective view of the input device according to an embodiment;

FIG. 7 is an appearance perspective view of the actuator member included in the input device according to an embodiment;

FIG. 8 is a bottom view of the actuator member included in the input device according to an embodiment;

FIG. 9 is a side view of the actuator member included in the input device according to an embodiment;

FIG. 10 is an appearance perspective view of the actuator member, which is a modification of the actuator member included in the input device according to an embodiment;

FIG. 11 is a bottom view of the actuator member, which is a modification of the actuator member included in the input device according to an embodiment;

FIGS. 12A to 12E are diagrams showing the operating load characteristics of the pressing switch included in the input device according to an embodiment; and

FIGS. 13A to 13E are cross-sectional views showing the internal structure of a pressing switch included in an input device according to an embodiment.

### DESCRIPTION OF THE PREFERRED EMBODIMENTS

The following describes an embodiment with reference to the drawings. For convenience in the following description, the X-axis direction in the FIGURE(the direction perpendicular to the virtual pivoting center axis of the knob 130) is referred to as the front-rear direction, the Y-axis direction in the FIGURE(the direction parallel to the virtual pivoting center axis of the knob 130) is referred to as the left-right direction, and the Z-axis direction in the FIGURE(the direction orthogonal to both the X-axis and Y-axis) is referred to as the vertical direction. The positive direction of the X-axis is forward, the positive direction of the Y-axis is right, and the positive direction of the Z-axis is upward. Additionally, the positive direction of the Z-axis and upward direction are examples of "one side" while the negative direction of the Z- axis and downward direction are examples of "the other side". They indicate the relative positional relationship within the device and do not limit the installation direction or the operation direction of the device. All devices with equivalent relative positional relationships within the device including those with the different installation direction or the different operation direction are included in the scope of rights of the present invention.

### Input Device 100 Configuration

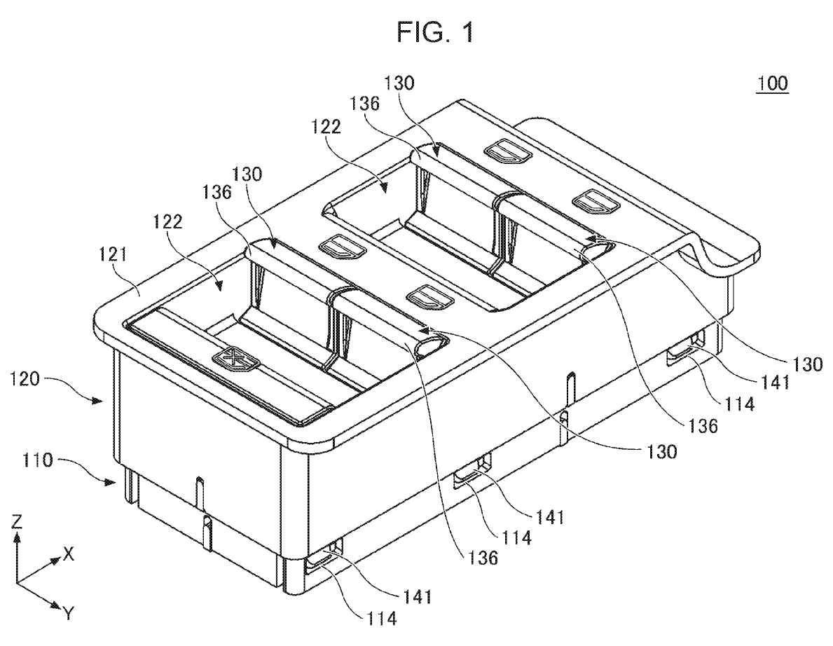

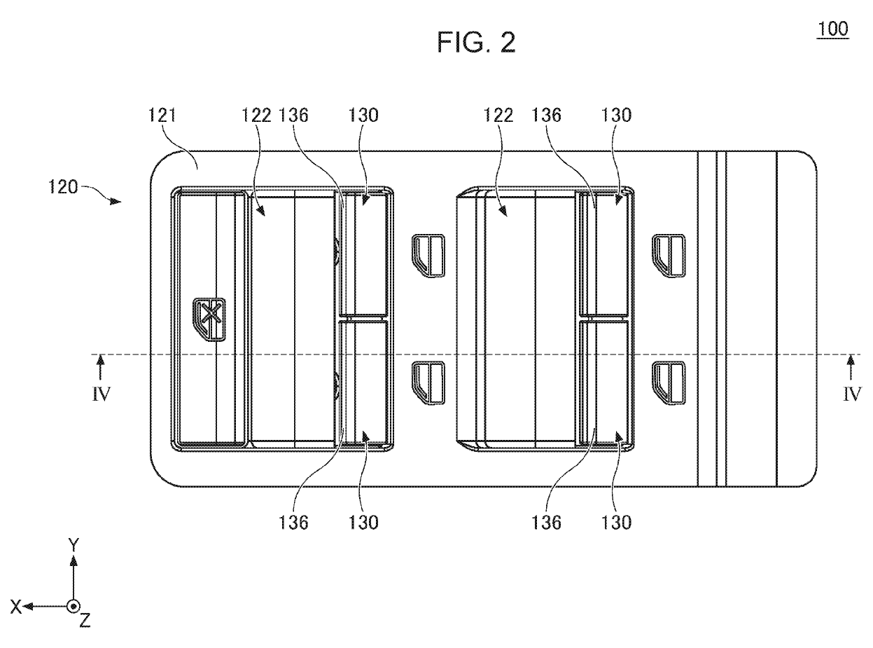

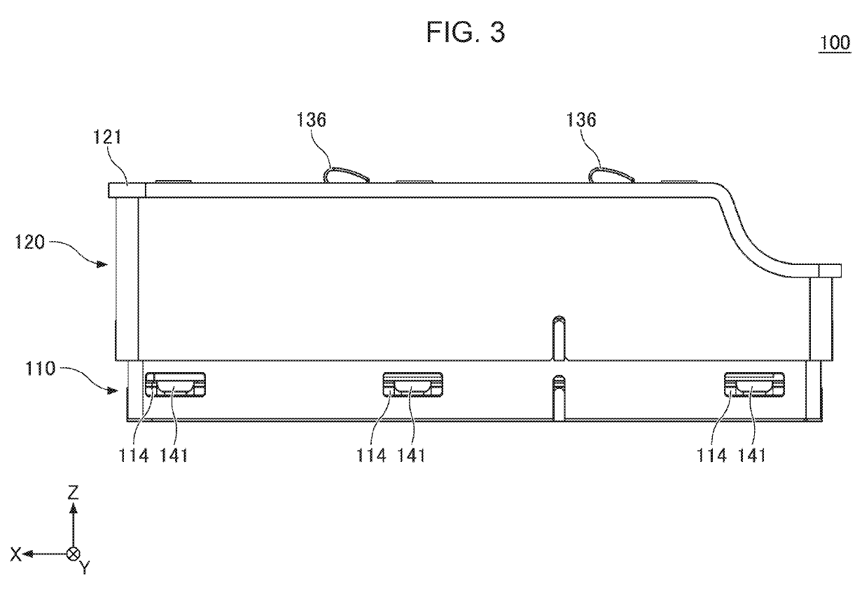

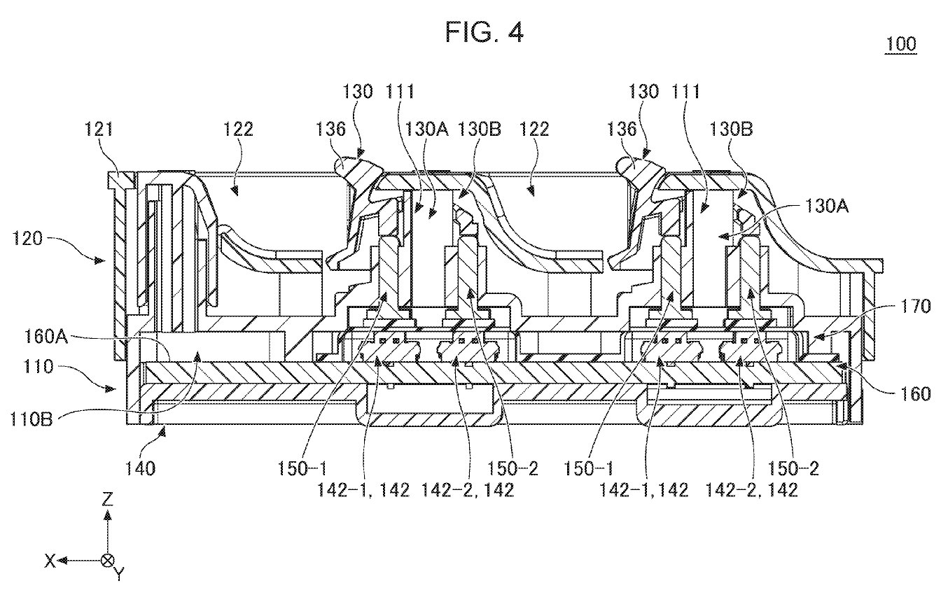

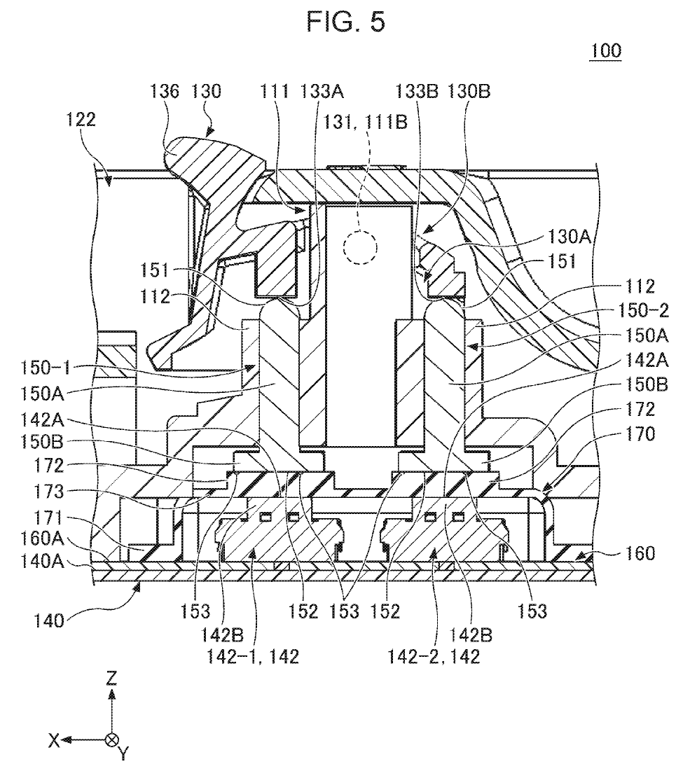

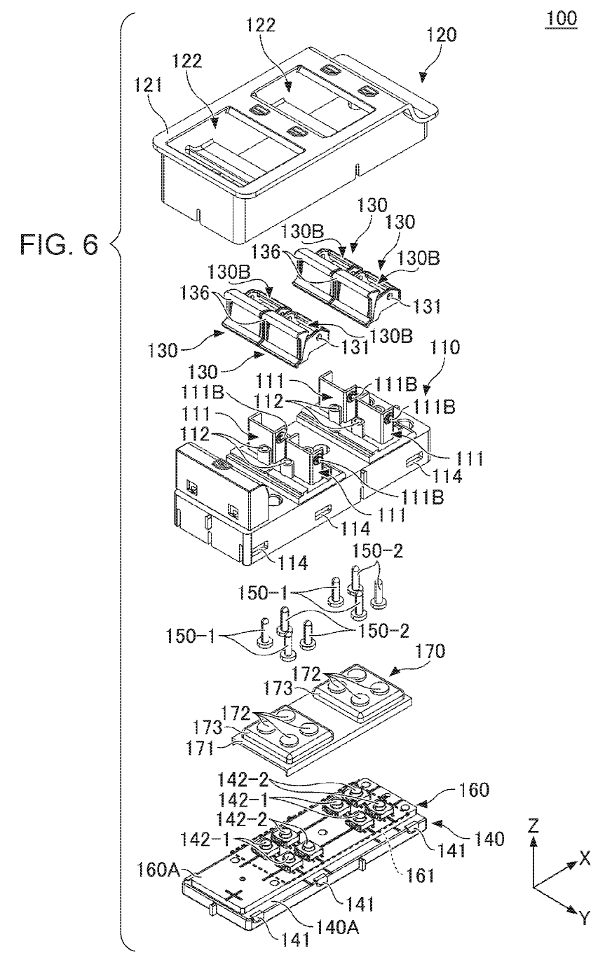

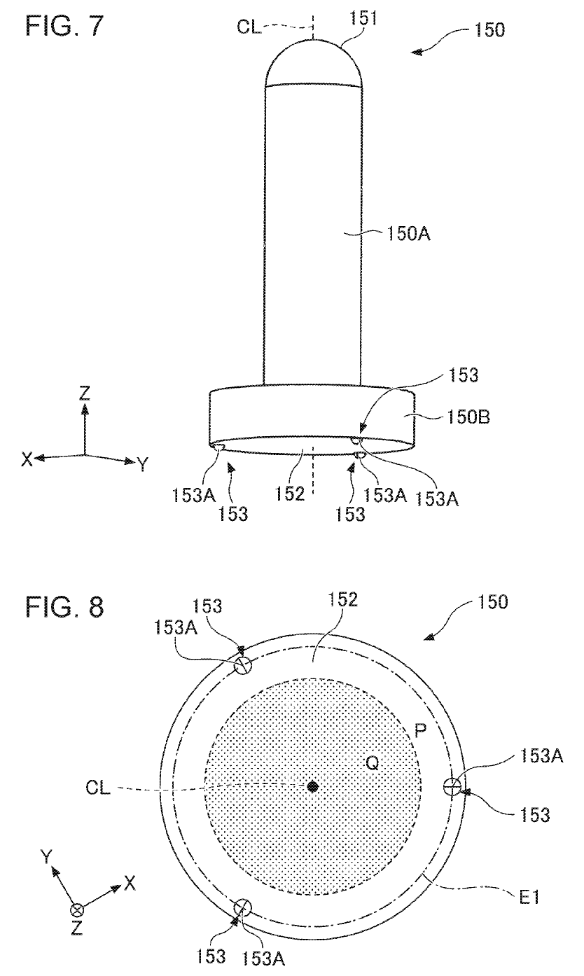

FIG. 1 is an appearance perspective view of an input device 100 according to an embodiment. FIG. 2 is a plan view of the input device 100 according to an embodiment. FIG. 3 is a left side view of the input device 100 according to an embodiment. FIG. 4 is a cross-sectional view of the input device 100 according to an embodiment, taken along IV-IV section line shown in FIG. 2. FIG. 5 is a partial enlarged view of the cross-sectional view shown in FIG. 4. FIG. 6 is an exploded perspective view of the input device 100 according to an embodiment. FIG. 7 is an appearance perspective view of an actuator member 150 included in the input device 100 according to an embodiment.

The input device 100 shown in FIGS. 1 to 6 can be installed in vehicles such as automobiles and used as an input device for operating an electrically driven in-vehicle devices (for example, an electric power window).

As shown in FIGS. 1 and 2, the input device 100 includes two knobs 130 disposed in the left-right direction (the Y-axis direction) on the front side (the positive direction of the X-axis), and two knobs 130 disposed in the left-right direction (the Y-axis direction) on the rear side (the negative direction of the X-axis). The input device 100 can drive four target devices (for example, electric power windows) by performing a pressing operation or a pulling up operation on the four knobs 130.

As shown in FIGS. 1 to 6, the input device 100 comprises a housing 110, a panel member 120, four knobs 130, a cover 140, eight actuator members 150, a substrate 160, and a rubber member 170.

The housing 110 is a resin member having a hollow structure with an opening at its bottom. The housing 110 is fixed to the substrate 160 and the cover 140. In the present embodiment, the panel member 120, the housing 110, and the cover 140 are assembled to form a box body having a substantially rectangular prism shape. For example, the housing 110 is formed by injection molding. The interior of the housing 110 accommodates the cover 140, the substrate 160, and the rubber member 170. In the present embodiment, the panel member 120, the housing 110, the substrate 160, and the cover 140 are fixed to each other using bolts and screws (not shown).

As shown in FIG. 6, four support portions 111 are provided on the upper part of the housing 110 to pivotably support the four knobs 130. Each of the four support portions 111 has a substantially rectangular cylindrical shape extending vertically in the vertical direction (the Z-axis direction) relative to the substrate 160. The four support portions 111 are provided at a location corresponding to the respective four knobs 130. Specifically, two of the four support portions 111 are disposed side by side in the left-right direction (the Y-axis direction) on the front side (the positive direction of the X-axis) of a top face 110A of the housing 110. Additionally, the other two of the four support portions 111 are disposed side by side in the left-right direction (the Y-axis direction) on the rear side (the negative direction of the X-axis) of the top face 110A of the housing 110.

Each support portion 111 has a pair of shaft portions 111B extending outward from each of a pair of the left and right side faces. The shaft portion 111B has a cylindrical shape, is fitted into bearing hole 131 formed in the knob 130, and pivotably supports the knob 130. The shaft portion 111B and the bearing hole 131 are formed on a virtual axis passing through the center of rotation of the knob 130. As shown in FIG. 5, the shaft portion 111B is disposed at a position between the two pressing switches 142 disposed side by side in the X-axis direction. In the present embodiment, the shaft portion 111B is disposed between the two pressing switches 142 disposed side by side in the X-axis direction.

The housing 110 has a first guide portion 112 (an example of a "first guide portion"). The first guide portion 112 has a cylindrical shape extending in the Z-axis direction perpendicular to the substrate 160, and is a member that movably guides a second guide portion 150A (an example of a "second guide portion") of the actuator member 150, described in detail later, in the Z-axis direction. The second guide portion 150A has a column shape extending in the Z-axis direction perpendicular to the substrate 160, and the first guide portion 112 has an inner wall face that slidably contacts the outer wall face of the second guide portion 150A.

In the present embodiment, the second guide portion 150A has a cylindrical shape, and the first guide portion 112 has a tubular shape with an inner wall having a concave curved surface shape that slidably contacts the cylindrical shape. As shown in FIGS. 4 to 6, the two first guide portions 112 are formed corresponding to each of the four support portions 111 formed in the housing 110. The two first guide portions 112 are disposed side by side in the front-rear direction with the support portion 111 interposed therebetween. That is, the housing 110 has a total of eight first guide portions 112. Each first guide portion 112 has a tubular shape extending in the vertical direction. Each first guide portion 112 movably supports the actuator member 150 in the vertical direction (the Z-axis direction) by having the second guide portion 150A of the actuator member 150 inserted through the first guide portion 112. In the present embodiment, the first guide portion 112 is configured so that the distance from the support portion 111 in the X-axis direction is set to be small. The shape forming the first guide portion 112 and the shape forming the support portion 111 partially overlap and are integrally formed.

The panel member 120 is a resin member having a hollow structure. The panel member 120 is provided above the housing 110 and covers the housing 110. As shown in FIG. 4, the interior of the hollow structure of the panel member 120 houses a portion of the knob 130, a portion of the housing 110, the actuator member 150 housed within the housing 110, and the pressing switch 142. The panel member 120 is, for example, a member that constitutes the console of a vehicle's driver seat. In the present embodiment, the panel member 120 and the housing 110 are fixed by snap-in engagement in direct contact with each other, but the panel member 120 and the housing 110 may be fixed indirectly via other members.

As shown in FIGS. 1, 2, and 6, the panel member 120 has a panel top face portion 121 with a planar shape parallel to the XY plane. The panel top face portion 121 of the panel member 120 has a rectangular shape with the front-rear direction (the Y-axis direction) as a longitudinal direction when viewed from above (the positive direction of the Z-axis) in plan view. The panel top face portion 121 has a rectangular opening 122 with the left-right direction (the Y-axis direction) as a longitudinal direction when viewed from above (the positive direction of the Z-axis) in plan view. The panel top face portion 121 has two openings 122 disposed side by side in the front-rear direction. The opening 122 is a hole for the operator to insert a finger when pulling and operating an operation portion 136 of the knob 130. The operation portion 136 of the knob 130 is disposed at the rear of the opening 122 and is exposed when the input device 100 is viewed from above, and receives an operating force from the operator who inserts a finger into the opening 122.

Knob 130 is a resin member that receives an operating force from the operator and transitions. In the present embodiment, the knob 130 is a member that rotates when subjected to an operating force from the operator and returns to the neutral position due to the restoring force from the elastic member in the neutral state in which the knob 130 is released from the operating force. As shown in FIGS. 4 to 6, in the present embodiment, the input device 100 has the four knobs 130. Knob 130 is a member that transmits the applied operating force to the actuator member 150. The knob 130 has the operation portion 136, the bearing hole 131, a first pressing portion 133A, and a second pressing portion 133B, with the configuration connecting them being formed to include a hollow structure. The operation portion 136 is shaped to come into contact with the operator's finger and receive an operating force from the operator. The bearing hole 131 is shaped to rotatably support the knob 130 when assembled with the shaft portion 111B of the housing 110. Each of the first pressing portion 133A and the second pressing portion 133B have a shape that contacts the actuator member 150.

During the assembly process, in the hollow structure, the support portion 111 of the housing 110 is inserted into an upper opening 130B penetrated and formed in the knob 130 in the vertical direction, from below (the negative direction of the Z-axis). Each of the four knobs 130 is disposed at the upper position of the housing 110 and is connected to the corresponding support portion 111 of the housing 110, thereby being pivotably supported by the housing 110. The knob 130 has a bearing hole 131 in each of the left and right side faces thereof. The pair of left and right shaft portions 111B provided on the support portion 111 of the housing 110 is fitted into the pair of the corresponding left and right bearing holes 131, so that each knob 130 is rotatably supported to the housing 110 about the virtual pivoting center axis of the pair of the left and right shaft portions 111B.

The operation portion 136 is shaped to receive the pressing operating force and pulling operating force applied by the operator. As shown in FIGS. 1 and 5, the operation portion 136 has a shape that extends in the Y-axis direction, the shape being formed continuously with the upper end portion of a front wall portion that is substantially parallel to the YZ plane, the front wall portion being formed on the front side (the positive direction of the X-axis) of the knob 130. The operation portion 136 is disposed inside the opening 122 along the rear (the negative direction of the X-axis) end of the opening 122 formed in the panel member 120. In the neutral state, the front wall portion of the knob 130 extends and is formed to a position immediately adjacent to the lower part of the rear end of the opening 122, and the operation portion 136, formed continuously with the upper end of the front wall portion, is disposed along the rear end of the opening 122. In the present embodiment, the operation portion 136 is formed to protrude forward (the positive direction of the X-axis) and upward (the positive direction of the Z-axis) from a position immediately adjacent to the rear end of the opening 122, but the operation portion 136 may have a shape parallel to the panel top face portion 121.

As shown in FIG. 5, in an internal space 130A of the knob 130, the first pressing portion 133A is provided in front of (the positive direction of the X-axis) the pair of the left and right bearing holes 131. The first pressing portion 133A has a planar shape and is configured to face downward, and is in contact with a distal end portion 151 formed at the upper part of the actuator member 150-1. When a pressing operating force is applied to the operation portion 136, causing the knob 130 to rotate counterclockwise with respect to the paper of FIG. 5 about the shaft portion 111B, the first pressing portion 133A transitions downward (the negative direction of the Z-axis) and presses the actuator member 150-1.

In the internal space 130A of the knob 130, the second pressing portion 133B is provided behind (the negative direction of the X-axis) the pair of the left and right bearing holes 131. The second pressing portion 133B has a planar shape and is configured to face downward, and is in contact with the distal end portion 151 formed at the upper end of the actuator member 150-2. When the operator applies an upward pulling operating force to the operation portion 136, causing the knob 130 to rotate clockwise with respect to the paper of FIG. 5 about the shaft portion 111B, the second pressing portion 133B transitions downward (the negative direction of the Z-axis) and presses the actuator member 150-2.

The cover 140 is a member disposed below the substrate 160, in contact with the substrate 160, and supporting the substrate 160 from below. As shown in FIG. 4, the cover 140 is a rigid, flat resin member that closes a lower opening 110B of the housing 110 by being fitted into the lower opening 110B. The cover 140 has a rectangular shape with the front-rear direction (X-axis direction) as a longitudinal direction when viewed from above in plan view. As shown in FIGS. 4 and 6, a plurality of engagement claws 141 is provided on the side face of the cover 140.

The cover 140 is fixed to the housing 110 in an orientation where a top face 140A is parallel to the XY plane when a plurality of engagement claws 141 is engaged with a plurality of openings 114 formed in the side face of the housing 110.

As shown in FIGS. 4 and 6, the substrate 160 is a flat member made of resin, and extending parallel to the XY plane, the flat member being stacked on the top face 140A of the cover 140 and supported from below by the cover 140. The substrate 160 has a rectangular shape with the front-rear direction (X-axis direction) as a longitudinal direction when viewed from above in plan view. Various electronic components are mounted on a top face 160A of the substrate 160. The substrate 160 and various electronic components are covered by a waterproof sheet (the rubber member 170) provided above the substrate 160.

Eight pressing switches 142 are mounted on the top face 160A of the substrate 160. Specifically, on the top face 160A of the substrate 160, two pressing switches 142-1 and 142-2 are disposed side by side in the front-rear direction (X-axis direction) and located below the four knobs 130, with the pressing switch 142-1 disposed in front of (the positive direction of the X-axis) the pressing switch 142-2. The pressing switch 142 is a switch mechanism that generates a signal when pressed beyond a predetermined pressing amount.

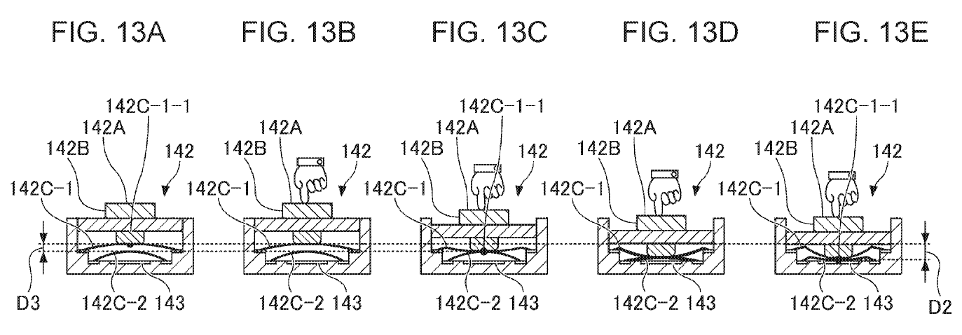

As shown in FIGS. 13A to 13E, the pressing switch 142 includes a metal, elastic restoring member 142C (restoring members 142C-1 and 142C-2). The restoring member 142C has a convex shape when a top face 142A is not being pressed. The restoring member 142C undergoes elastic deformation and inverts into a concave shape when the top face 142A is pressed, and returns to a convex shape when the pressure on the top face 142A is released. The pressing switch 142 provides a click sensation to the operator when the restoring member 142C reverses or returns.

Actuator member 150 is a member provided between the knob 130 and the pressing switch 142, transmitting the operating force from the knob 130 and the restoring force from the pressing switch 142. As shown in FIGS. 4 to 6, in the present embodiment, the two actuator members 150 are provided for each knob 130. The input device 100 has the four knobs 130, so that the input device 100 has the eight actuator members 150.

As shown in FIG. 7, the actuator member 150 has the second guide portion 150A with a cylindrical shape extending in the vertical direction (the Z-axis direction). The second guide portion 150A is inserted into the first guide portion 112 of the housing 110 shown in FIGS. 5 and 6, and has a shape that slidably contacts the first guide portion 112.

As shown in FIG. 7, the actuator member 150 has the distal end portion 151 provided on the upper part of the second guide portion 150A.

The actuator member 150 has a plate portion 150B that is provided on the lower part of the second guide portion 150A and has a plate shape extending in parallel to the substrate 160 (the XY plane direction).

The actuator member 150 has a lower face portion 152 (an example of a "second contact portion") of the plate portion 150B and a protrusion 153 extending downward from the lower face portion 152. The protrusion 153 has a distal end 153A. The first guide portion 112 and the second guide portion 150A have guide shapes that regulate the direction of movement of the actuator member 150. The second guide portion 150A is inserted into the first guide portion 112 of the housing 110, thereby regulating the actuator member 150 to move in the vertical direction (the Z-axis direction) but not to move in the front-rear and left-right directions.

The distal end portion 151 is shaped to contact either the first pressing portion 133A or the second pressing portion 133B of the knob 130. In the present embodiment, the distal end portion 151 has a curved surface shape that includes a portion of a spherical shape. When the knob 130 shown in FIG. 5 rotates counterclockwise when viewed from a direction perpendicular to the paper about the shaft portion 111B, the first pressing portion 133A of the knob 130 presses the distal end portion 151 downward. Consequently, the actuator member 150 slides in the negative direction of the Z-axis as the knob 130 rotates. In the present embodiment, the plate portion 150B has a cylindrical shape with a common center axis with the second guide portion 150A.

As shown in FIG. 5, the plate portion 150B of the actuator member 150 is disposed above the pressing switch 142. A thick-walled portion 172 of the rubber member 170 is sandwiched by the actuator member 150 and the pressing switch 142. The plate portion 150B of the actuator member 150 is supported by the pressing switch 142 from below via the thick-walled portion 172 of the rubber member 170. The lower face portion 152 of the plate portion 150B of the actuator member 150 has a planar shape and is provided in contact with the thick-walled portion 172 of the rubber member 170. The lower face portion 152 of the plate portion 150B is disposed facing the top face 142A (an example of a "first contact portion") of a stem member 142B of the pressing switch 142, with the thick-walled portion 172 interposed therebetween. When viewed in plan view, the area occupied by the protrusion 153 is set to be significantly smaller than the area occupied by the lower face portion 152 of the plate portion 150B. Actuator member 150 is disposed inside the first guide portion 112 with the distal end portion 151 facing upward.

As shown in FIG. 6, the input device 100 has the front (the positive direction of the X-axis) actuator member 150-1 and the rear (the negative direction of the X-axis) actuator member 150-2 for each of the four knobs 130.

As shown in FIG. 5, the actuator member 150-1 has the distal end portion 151, which is the upper end (the positive direction of the Z-axis), in contact with the first pressing portion 133A of the knob 130, and the lower face portion 152 in contact with the top face of the pressing switch 142-1 via the rubber member 170. Actuator member 150-2 has the distal end portion 151 in contact with the second pressing portion 133B of the knob 130, and the lower face portion 152 in contact with the top face of pressing switch 142-2 via the rubber member 170.

The rubber member 170 is a sheet-like member made of an elastic material (for example, rubber, silicon, etc.) that is stacked on the upper side (the positive direction of the Z-axis) of the substrate 160 and covers the top face 160A of the substrate 160 and the eight pressing switches 142. The rubber member 170 is a waterproof cover for the substrate 160. The rubber member 170 is preferably provided to cover all wiring disposed on the substrate 160.

### Configuration And Operation Of Pressing Mechanism Included In Input Device 100

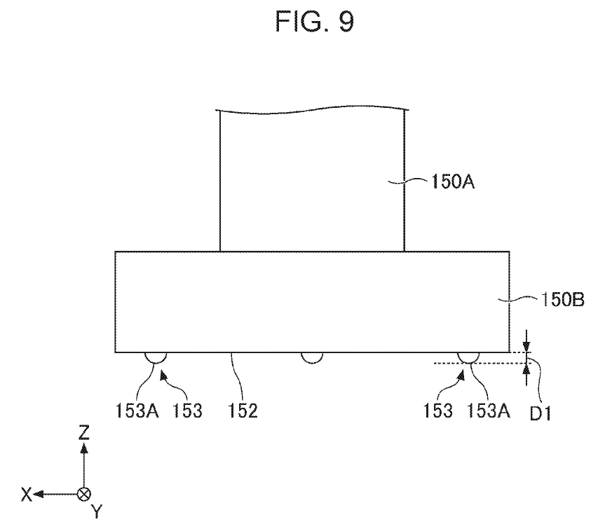

FIG. 8 is a bottom view of the actuator member 150 included in the input device 100 according to an embodiment. FIG. 9 is a side view of the actuator member 150 included in the input device 100 according to an embodiment.

The pressing mechanism included in the input device 100 is a mechanism designed to extract the component perpendicular to the substrate 160 from the motion of the knob 130, which rotates under operating force, and to press the pressing switch 142. As shown in FIG. 5, the pressing mechanism included in the input device 100 includes the knob 130, the actuator member 150, and the rubber member 170.

The top face 142A (an example of the "first contact portion") of the pressing switch 142 has a planar shape and contacts a portion (the thick-walled portion 172) of the rubber member 170 at the underside (the negative direction of the Z-axis) of the rubber member 170.

Furthermore, as shown in FIG. 5, the lower face portion 152 of the actuator member 150 has a planar shape and faces the top face 142A (the first contact portion) of the pressing switch 142, and contacts the thick-walled portion 172 of the rubber member 170 at the upper side (the positive direction of the Z-axis) of the rubber member 170.

Specifically, the thick-walled portion 172 of the rubber member 170 is sandwiched by the top face 142A of the pressing switch 142 and the lower face portion 152 of the actuator member 150.

Therefore, in the input device 100 according to an embodiment, when the knob 130 is not operated as shown in FIG. 5, the first pressing portion 133A and the second pressing portion 133B of the knob 130 are biased by the elastic element via the rubber member 170, the actuator member 150-1, and the actuator member 150-2 upward (the positive direction of the Z-axis) equally in the front-rear direction. In the present embodiment, the elastic element includes the restoring member 142C (the restoring members 142C-1 and 142C-2) shown in FIGS. 13A to 13E, the protrusions 153 shown in FIGS. 7 and 9, and the thick-walled portion 172 shown in FIG. 5. This allows the knob 130 to maintain the neutral state when the knob 130 is not being operated. Furthermore, this ensures that the tensioned state of the knob 130 and the actuator members 150-1 and 150-2 is continuously maintained, thereby suppressing backlash. In this manner, by adjusting the stroke of the elastic element, the state in which tension is maintained between specific members (for example, between the knob 130, the actuator member 150, and the pressing switch 142) is referred to as a state with pre-tension applied.

When the operator presses down the operation portion 136 of the knob 130, the knob 130 rotates counterclockwise with respect to the paper of FIG. 5 about the shaft portion 111B. Additionally, the first pressing portion 133A of the knob 130 presses the pressing switch 142-1 via the actuator member 150-1 and the rubber member 170. As a result, the pressing switch 142-1 switches to the switch-on state and outputs a detection signal.

Furthermore, when the operator pulls up the operation portion 136 of the knob 130, the knob 130 rotates clockwise with respect to the paper of FIG. 5 about the shaft portion 111B. Additionally, the second pressing portion 133B of the knob 130 presses the pressing switch 142-2 via the actuator member 150-2 and the rubber member 170. As a result, the pressing switch 142-2 switches to the switch-on state and outputs a detection signal.

Furthermore, when the operation of the knob 130 is released, the knob 130 returns to the neutral state using the biasing force from either pressing switch 142-1 or pressing switch 142-2 and maintains the neutral state.

The actuator members 150-1 and 150-2 have the same shape as the actuator member 150 shown in FIGS. 7 to 9. Here, as shown in FIGS. 7 to 9, the actuator member 150 has the protrusion 153 extending downward (the negative direction of the Z-axis) from the lower face portion 152. In the examples shown in FIGS. 7 to 9, the actuator member 150 has the three protrusions 153 disposed at equal intervals on the same circumference (on the same circumference of a circle E1 centered on a center axis CL of the second guide portion 150A) at the lower face portion 152. Furthermore, in the examples shown in FIGS. 7 to 9, the protrusion 153 has a hemispherical shape. As shown in FIG. 5, when the lower face portion 152 of the actuator member 150 contacts the rubber member 170, the protrusion 153 of the actuator member 150 presses and elastically deforms the rubber member 170.

In the input device 100 according to an embodiment, in the neutral state in which the knob 130 is released from an operating force applied to the knob 130, the protrusion 153 of the actuator member 150 presses and elastically deforms the thick-walled portion 172 of the rubber member 170. Furthermore, since a restoring force is generated in the thick-walled portion 172 of the rubber member 170 elastically deformed by this action, pre-tension can be applied to the pressing switch 142 and actuator member 150 contacting with each other from above and below using the stroke of the restoring force.

Accordingly, in setting the pre-tension, the input device 100 according to an embodiment utilizes not only the stroke of the restoring member 142C of the pressing switch 142 but also the stroke of the restoring force of the thick-walled portion 172 of the rubber member 170. This allows for the setting of an amount of pre-tension with a margin, taking into account dimensional variations in related components.

Accordingly, in the input device 100 according to an embodiment, the pre-tension is set additionally utilizing the stroke of the restoring force derived from the protrusion 153 and the rubber member 170 as an assist. Accordingly, in the input device 100 according to an embodiment, the stroke of the restoring member 142C of the pressing switch 142 is set by allocating its entire amount to the stroke of the input operation, and then using, in an auxiliary manner, the stroke of the restoring force derived from the rubber member 170 for the amount required as pre-tension, further taking into account dimensional variations. First, setting of the operating tactile sensation is performed using the pressing switch 142 that satisfies the operating tactile sensation specifications, then, for the setting of the pre-tension, the pre-tension is set with a margin, taking into account dimensional variations in the components while maintaining the required operating tactile sensation, by setting, in an auxiliary manner, the restoring force stroke using members other than the switch 142, such as the thick-walled portion 172 of the rubber member 170 and the protrusion 153 of the actuator member 150, based on the stroke and dimensions of the switch 142. Furthermore, since the pre-tension is designed using the elastic force of the rubber member 170 without requiring new additional components, costs will not increase.

Now, referring to FIG. 5, the specific configuration of the rubber member 170 will be described. As shown in FIG. 5, the rubber member 170 has a base portion 171, the thick-walled portion 172, and a thin-walled portion 173.

The base portion 171 is a horizontal, plate-like portion provided in contact with the top face 160A of the substrate 160. The base portion 171 is provided with the pressing switch 142 and the portion surrounding the pressing switch 142 on the top face 160A of the substrate 160 shown in FIG. 6 avoided. Additionally, the pressing switch 142 and the portion surrounding the pressing switch 142 are covered by the thin-walled portion 173 and the thick-walled portion 172.

The thick-walled portion 172 is an example of a "first portion" and, as shown in FIG. 5, is provided in continuity with the thin-walled portion 173, and has a plate-like shape with a predetermined thickness dimension that is thicker than that of the thin-walled portion 173. The role of the thick-walled portion 172 is to serve as an elastic plate. The thick-walled portion 172 is sandwiched by the top face 142A of the corresponding pressing switch 142 and the lower face portion 152 of the corresponding actuator member 150. When the thick-walled portion 172 is pressed downward (the negative direction of the Z-axis) and deformed by the protrusion 153 provided on the lower face portion 152 of the actuator member 150, the thick-walled portion 172 generates a restoring force and biases the protrusion 153 upward, in the restoring direction (the negative direction of the Z-axis). The actuator member 150 is biased upward (the negative direction of the Z-axis) by this restoring force.

The thin-walled portion 173 is an example of a "second portion" and has a shape extending upward (the positive direction of the Z-axis) from the base portion 171 side end of the pressing switch 142 and spanning over the pressing switch 142. The thin-walled portion 173 is provided connecting the base portion 171 and the thick-walled portion 172, has a thickness dimension smaller than that of the thick-walled portion 172, and has flexibility.

Within the strength limits of the material constituting the rubber member 170, setting the thickness dimension of the thin-walled portion 173 to be smaller reduces the tactile sensation generated by deformation of the thin-walled portion 173. At this time, the tactile sensation transmitted to the operator's finger when operating the knob 130 is predominantly generated by the restoring force of the metal restoring member 142C, and the tactile sensation provided by the rubber member 170 no longer interferes with the tactile sensation by the restoring force. Accordingly, designing the operating tactile sensation is easier. Therefore, the thickness dimension of the thin-walled portion 173 is preferably set to be small within the range that does not compromise the waterproofing sheet function of the rubber member 170. Furthermore, in a case where the thickness dimension of the thin-walled portion 173 is reduced to the extent that the thin-walled portion 173 sags when gripping the rubber member 170 individually during the assembly process, the convenience of the assembly process is compromised. Therefore, the thickness dimension of the thin-walled portion 173 is preferably set as small as possible while maintaining a size sufficient to ensure that the thin-walled portion 173 has the strength required to prevent sagging due to the combined weight of the thin-walled portion 173 and the thick-walled portion 172.

The base portion 171 serves as the foundation for the rubber member 170 and supports the thin-walled portion 173. The thin-walled portion 173 is supported by the base portion 171 and supports the thick-walled portion 172. The thick-walled portion 172 is structurally supported by the thin-walled portion 173 and the top face 142A of the pressing switch 142. However, since the physical strength of the thin-walled portion 173 is low due to its small thickness dimension, the thick-walled portion 172 is primarily supported by the top face 142A of the pressing switch 142.

Thus, the input device 100 according to an embodiment includes the protrusion 153 of the actuator member 150, and the rubber member 170 has the thick-walled portion 172. In the neutral state, the protrusion 153 presses the thick-walled portion 172, thereby generating a restoring force. Furthermore, utilizing this restoring force, pre-tension is applied between the knob 130, the actuator member 150, and the pressing switch 142. The thick-walled portion 172 is configured to have a sufficient thickness dimension to generate a restoring force in the Z-axis direction when elastically deformed by the protrusion 153. Furthermore, by providing the highly flexible thin-walled portion 173 between the base portion 171 and the thick-walled portion 172, there is no possibility of hindering the transition of the thick-walled portion 172 even when the thickness dimension of the thick-walled portion 172 is increased. Furthermore, providing the thin-walled portion 173 facilitates the design of the operating tactile sensation. Furthermore, the input device 100 according to an embodiment facilitates tactile sensation design by the rubber member 170 having the thin-walled portion 173.

The contact area between the protrusion 153 and the thick-walled portion 172 (the first portion) is small, so that the thick-walled portion 172 (the first portion) pressed by the protrusion 153 easily undergoes localized elastic deformation. At this point, a restoring force proportional to the amount of deformation in the thick-walled portion 172 is generated. On the other hand, the planar shape of the lower face portion 152 (the second contact portion) of the actuator member 150 does not cause elastic deformation of the thick-walled portion 172 (the first portion). Alternatively, even when elastic deformation occurs, the amount of deformation is so small that it need not be considered. The reasons are as follows. The contact area between the planar shape of the lower face portion 152 (the second contact portion) and the thick-walled portion 172 (the first portion) is large, so that an amount (volume) of the thick-walled portion 172 (the first portion) undergoing elastic deformation is large. Of course, when a force commensurate with the amount is transmitted, the thick-walled portion 172 (the first portion) can undergo elastic deformation, but, in most cases, the metal restoring member 142C within the pressing switch 142 begins to deform before that occurs. Therefore, the thick-walled portion 172 (the first portion) does not undergo elastic deformation until the metal restoring member 142C completes its deformation to the state shown in FIG. 13E.

As shown in FIGS. 7 and 8, the actuator member 150 of the input device 100 according to an embodiment has the three protrusions 153. Furthermore, when viewed from the negative direction of the Z-axis in plan view, the three protrusions 153 are disposed on the circumference of the circle E1 centered on the center axis CL of the second guide portion 150A. The number of protrusions 153 may be more than three. When the number of protrusions 153 exceeds three, it is preferable that at least three protrusions 153 be disposed on the circumference of the circle E1 centered on the center axis CL of the second guide portion 150A.

Accordingly, the input device 100 according to an embodiment presses the thick-walled portion 172 of the rubber member 170 using the three protrusions 153, making it easier to adjust the direction of the resultant force of the restoring force generated, compared with a configuration using only one protrusion 153, for example. Therefore, it is easier to suppress the loss generated when biasing the actuator member 150 using the generated restoring force. Furthermore, the three protrusions 153 provided on the actuator member 150 of the input device 100 according to an embodiment have the same height dimension (a distance D1 shown in FIG. 9). As a result, the load on the thick-walled portion 172 of the rubber member 170 is equally distributed across three points. Accordingly, the input device 100 according to an embodiment can suppress defects where the thick-walled portion 172 of the rubber member 170 is damaged by the protrusion 153.

In the input device 100 according to an embodiment, the substrate 160 has a wiring region 161 (see FIG. 6) where a group of wiring (not shown) and eight pressing switches 142 are provided on the top face 160A, and the rubber member 170 covers the entire wiring region 161.

This allows the input device 100 according to an embodiment to enhance the waterproofing of the wiring (not shown) and the eight pressing switches 142 provided in the wiring region 161. Furthermore, in a case where a drainage groove is formed in the wiring region 161, the rubber member 170 may have a shape that avoids the drainage groove.

As shown in FIGS. 5 and 6, in the input device 100 according to an embodiment, the lower face portion 152 (the second contact portion) of the actuator member 150 and the top face 142A (the first contact portion) of the pressing switch 142 are disposed facing each other with the thick-walled portion 172 of the rubber member 170 interposed therebetween. Furthermore, the top face 142A (the first contact portion) has a smaller area than the lower face portion 152 (the second contact portion), and the entire top face 142A (the first contact portion) is disposed to overlap the lower face portion 152 (the second contact portion). Furthermore, the entire top face 142A (the first contact portion) is disposed inward of the edge of the lower face portion 152 (the second contact portion).

Furthermore, in the input device 100 according to an embodiment, the lower face portion 152 (the second contact portion) of the actuator member 150 has a smaller area than the thick-walled portion 172 (the first portion) of the rubber member 170, and the entire lower face portion 152 (the second contact portion) overlaps the thick-walled portion 172 (the first portion).

As shown in FIG. 8, the lower face portion 152 (the second contact portion) of the actuator member 150 when viewed in the Z-axis direction in plan view, has a first region Q that has the same dimensions as the top face 142A (the first contact portion) of the pressing switch 142 and overlaps and faces the entire top face 142A (the first contact portion). Furthermore, the lower face portion 152 (the second contact portion) has a second region P that is located outside the first region Q and does not overlap the top face 142A (the first contact portion) of the pressing switch 142. Furthermore, as shown in FIG. 8, the protrusion 153 of the actuator member 150 is formed in the second region P when viewed in the Z-axis direction in plan view.

Accordingly, the input device 100 according to an embodiment is configured so that the top face 142A (the first contact portion) of the pressing switch 142 and the lower face portion 152 (the second contact portion) of the actuator member 150 contact each other with their planar shapes and press against each other.

As a result, no gap derived from the protrusion 153 is generated at the contact face between the first region Q of the lower face portion 152 (the second contact portion), which forms a transmission path for the operating force from the actuator member 150 to the top face 142A, and the thick-walled portion 172, nor at the contact face between the thick-walled portion 172 and the top face 142A (the first contact portion). That is, the contact area is maximized. Furthermore, the orientation of the contact surface is perpendicular to the direction in which the operating force is transmitted from the actuator member 150 to the top face 142A.

Therefore, the input device 100 according to an embodiment does not incur transmission loss of the operating force due to the protrusion 153 when transmitting the operating force from the operator, and the operating force from the operator is easily transmitted to the pressing switch 142. This contributes to ease of input operation and reliability of input timing. Furthermore, as a result, the operating load of the pressing switch 142 generated by the metal restoring member 142C is more easily transmitted to the operator's finger. This contributes to the quality of the tactile sensation felt when the pressing switch 142 is turned ON/OFF.

Furthermore, in the input device 100 according to an embodiment, the pressing switch 142 includes the stem member 142B that is provided close to the actuator member 150 and slides and presses the restoring member 142C when the actuator member 150 slides. The top face 142A (an example of the "first contact portion") of the pressing switch 142 is formed on the upper side (the positive direction of the Z-axis) of the stem member 142B.

Furthermore, in the input device 100 according to an embodiment, the distal end 153A of the protrusion 153 of the actuator member 150 has a curved surface shape. As a result, the input device 100 according to an embodiment can reduce the possibility of the thick-walled portion 172 being damaged by the protrusion 153, thereby extending the service life of the rubber member 170.

However, not limited to this, the protrusion 153 of the actuator member 150 may have a tapered shape that is narrower toward the distal end 153A from the lower face portion 152 (the second contact portion).

As shown in FIG. 5, the input device 100 according to an embodiment includes the two pressing switches 142, the shaft portion 111B parallel to the Y-axis direction, the shaft portion 111B being positioned between the two pressing switches 142 when viewed in the Y-axis direction, and the knob 130 rotatably supported by the shaft portion 111B. Additionally, the knob 130 is pre-tensioned by the biasing forces from both restoring members 142C included in the two pressing switches 142.

Accordingly, the input device 100 according to an embodiment can apply pre-tension between the knob 130, the two actuator members 150, and the two pressing switches, by the biasing forces from both restoring members 142C included in the two pressing switches 142, in a neutral state in which the knob 130 is released from the operating force applied to the knob 130.

Furthermore, the input device 100 according to an embodiment, as shown in FIGS. 5 and 6, has the thin-walled portion 173 formed to extend upward (the positive direction of the Z-axis) from the base portion 171 of the rubber member 170 to cover the two pressing switches 142-1 and 142-2. Additionally, the two pressing switches 142-1 and 142-2 are disposed in the space formed between the thin-walled portion 173 and the substrate 160, located below the thin-walled portion 173 (the negative direction of the Z-axis). Specifically, the two pressing switches 142-1 and 142-2 provided for each knob 130 are covered by the same rubber member 170.

Accordingly, the input device 100 according to an embodiment can reduce the number of the thin-walled portions 173 formed in the rubber member 170, thereby enhancing the ease of forming the rubber member 170.

### One Modification Of Actuator Member 150

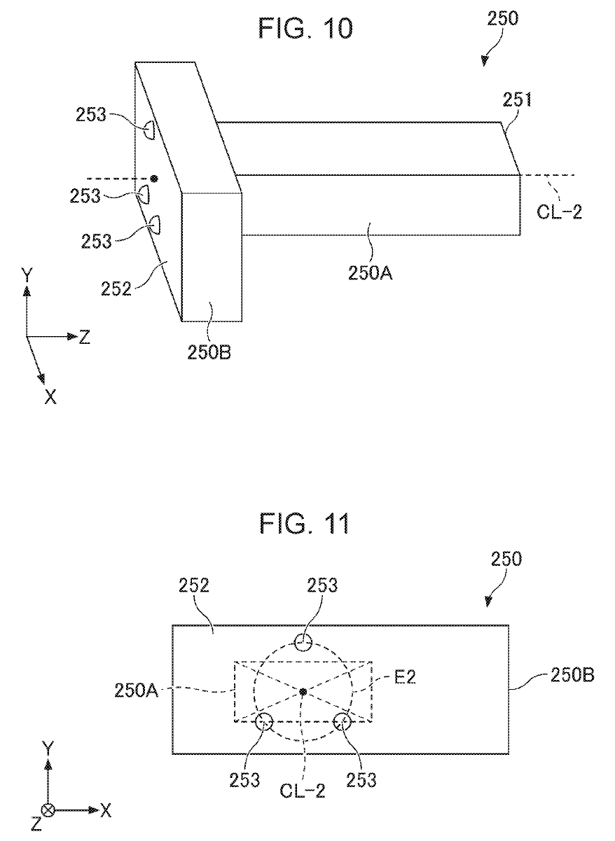

FIG. 10 is an appearance perspective view of an actuator member 250, which is a modification of the actuator member 150 included in the input device 100 according to an embodiment. FIG. 11 is a bottom view of the actuator member 250, which is a modification of the actuator member 150 included in the input device 100 according to an embodiment.

In the actuator member 150 shown in FIGS. 7 and 8, the plate portion 150B has a tubular shape, and as shown in FIG. 8, the contour of the lower face portion 152 (the second contact portion) when viewed from below (the negative direction of the Z-axis) in plan view is circular, but the shape of the plate portion need not include a circular shape. For example, as in the actuator member 250, shown in FIGS. 10 and 11, a plate portion 250B provided at the lower part may have a rectangular prism shape. Furthermore, the contour of a lower face portion 252 (the second contact portion) when viewed from below (the negative direction of the Z-axis) in plan view may have a square shape.

Furthermore, in the actuator member 150 shown in FIG. 7, the second guide portion 150A has a cylindrical shape, but the embodiment is not limited to this shape. For example, as in the actuator member 250 shown in FIGS. 10 and 11, a second guide portion 250A may have a rectangular prism shape. In this case, the first guide portion 112 of the housing 110 has a shape with a concave shape that contacts the rectangular prism shape.

Furthermore, for example, as in the actuator member 250 shown in FIGS. 10 and 11, a center axis CL-2 of the second guide portion 250A may be offset from the center of the lower face portion 252 (the second contact portion). In this case, as shown in FIG. 11, it is preferable that a plurality of protrusions 253 be provided on the same circumference of the circle E2 centered on the center axis CL-2 of the second guide portion 250A. Additionally, three or more protrusions 253 may be provided, but it is preferable that at least three of the protrusions 253 be provided on the same circumference of the circle E2 centered on the center axis CL-2.

### Operating Load Characteristics Of Pressing Switch 142

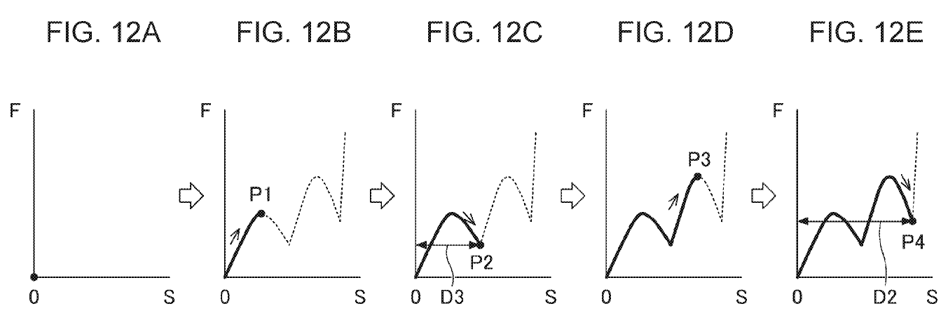

FIGS. 12A to 12E are diagrams showing the operating load characteristics of the pressing switch 142 included in the input device 100 according to an embodiment. In the graphs shown in FIGS. 12A to 12E, the horizontal axis indicates the stroke amount S of the stem member 142B, and the vertical axis indicates the operating load F of the pressing switch 142. FIGS. 13A to 13E are cross-sectional views showing the internal structure of the pressing switch 142 included in the input device 100 according to an embodiment. Additionally, FIGS. 13A to 13E correspond to the respective graphs in FIGS. 12A to 12E and specifically show how each component constituting the pressing switch 142 changes when the pressing switch 142 receives a pressing operating force.

As shown in FIG. 13A, the pressing switch 142 includes a first restoring member 142C-1 of the first stage in contact with the underside of the stem member 142B and a second restoring member 142C-2 of the second stage below the first restoring member 142C-1 of the first stage. Additionally, a fixed contact 143 is provided below the second restoring member 142C-2 of the second stage. The first restoring member 142C-1 includes a metal dome. The metal dome of the first restoring member 142C-1 includes a vertex 142C-1-1 that is provided in contact with the stem member 142B. The second restoring member 142C-2 includes a metal dome. The metal dome of the second restoring member 142C-2 is provided at a position where the metal dome contacts the inverted first restoring member 142C-1 when the metal dome of the first restoring member 142C-1 is pressed, deformed, and inverted.

FIG. 12A shows the operating load characteristics of the pressing switch 142 when the stroke amount is zero, where both the stroke amount S and the operating load F are zero. At this time, as shown in FIG. 13A, the lower end of the stem member 142B is in contact with the vertex 142C-1-1 of the metal dome of the first restoring member 142C-1. Furthermore, at this time, the first restoring member 142C-1 is slightly deflected, biasing the stem member 142B upward.

FIG. 12B shows the operating load characteristics of the pressing switch 142 when the operating load F reaches a first maximum value P1. As shown in FIG. 12B, the operating load F gradually increases until the operating load F reaches the first maximum value P1, due to the first restoring member 142C-1 of the first stage being pressed by the stem member 142B.

FIG. 12C shows the operating load characteristics of the pressing switch 142 when the operating load F reaches a valley portion P2 (an example of a "valley portion"). As shown in FIG. 12C, when the stem member 142B is further stroked from the position in FIG. 12B, the first restoring member 142C-1 of the first stage reverses, as shown in FIG. 13C. When the reversal of the first restoring member 142C-1 of the first stage begins, the operating load F temporarily decreases. When the vertex 142C-1-1 of the inverted first restoring member 142C-1 of the first stage contacts the second restoring member 142C-2 of the second stage, as shown in FIG. 12C, the operating load F reaches the valley portion P2. At this time, as shown in FIG. 13C, the pressing switch 142 turns to the first switch-on state as the first restoring member 142C-1 of the first stage is electrically connected to the second restoring member 142C-2 of the second stage.

FIG. 12D shows the operating load characteristics of the pressing switch 142 when the operating load F reaches a second maximum value P3. As shown in FIG. 12D, further stroking the stem member 142B from the position shown in FIG. 12C causes the operating load F to gradually increase as the stem member 142B presses the second restoring member 142C-2 of the second stage via the first restoring member 142C-1 of the first stage until the operating load F reaches the second maximum value P3.

FIG. 12E shows the operating load characteristics of the pressing switch 142 when the operating load F reaches a valley portion P4. As shown in FIG. 12E, when the stem member 142B is further stroked from the position in FIG. 12D, the second restoring member 142C-2 of the second stage reverses, as shown in FIG. 13E. At this point, the operating load F decreases. As the reversal progresses and the second restoring member 142C-2 of the second stage contacts the fixed contact 143, the operating load F reaches the valley portion P4, as shown in FIG. 12E. At this time, the pressing switch 142 turns to the second switch-on state as the second restoring member 142C-2 of the second stage is electrically connected to the fixed contact 143.

In this way, the pressing switch 142 is a double-action type pressing switch 142 that has two maximum values P1 and P3 on the operating load feel curve, enabling the two-stage ON/OFF operation. Additionally, the pressing switch 142 includes the first restoring member 142C-1 that reverses when the stem member 142B transitions beyond the first maximum value P1 from the neutral state, and the second restoring member 142C-2 that reverses when the stem member 142B transitions beyond the second maximum value P3 after the first restoring member 142C-1 reverses. Furthermore, as shown in FIG. 9, the distance D1 from the distal end 153A that is most distant from the lower face portion 152 (the second contact portion) of the protrusion 153 to the lower face portion 152 (the second contact portion) is adjusted to be smaller than a distance D2 shown in FIGS. 12 and 13. The distance D2 is the total dimension obtained by adding the stroke of the first restoring member 142C-1 to the stroke of the second restoring member 142C-2, and is the total distance by which the stem member 142B slides from the starting point (neutral position) to the end point when subjected to the pressing operating force. To explain more specifically, the distance D2 is a distance by which the stem member 142B of the first restoring member 142C-1 transitions from the neutral position shown in FIG. 13A to a position when the stem member 142B is fully depressed downward as shown in FIG. 13E.

Furthermore, when the input device 100 according to an embodiment includes the double-action type pressing switch 142, it is preferable that the distance D1 be adjusted to be smaller than the distance D3 shown in FIGS. 12 and 13. The distance D3 is a distance by which the stem member 142B transitions from the neutral state to the valley portion P2, where the operating load F drops to a low level, between the first maximum value P1 and the second maximum value P3 (that is, until the switch turns to the first switch-on state). The distance D3 is a distance by which the contact point (the vertex 142C-1-1) between the stem member 142B and the first restoring member 142C-1 transitions during the period from the neutral state shown in FIG. 13A to the time when the first restoring member 142C-1 is pressed and deformed to contact the second restoring member 142C-2 shown in FIG. 13C.

Accordingly, the input device 100 according to an embodiment can set the protrusion amount from the lower face portion 152 (the second contact portion) of the protrusion 153 of the actuator member 150 to an appropriate amount, and can prevent the pressing switch 142 from turning to the first switch-on state due to excessive pressing to the top face 142A (the first contact portion) of the pressing switch 142 by the protrusion 153 of the actuator member 150, even when no operating force is applied to the knob 130. In addition, with this configuration, the input device 100 can easily perform adjustment to deliver an operating tactile sensation analogous to an operating tactile sensation provided by the input device in the related art.

In the embodiment of the present application, the first restoring member 142C-1 and the second restoring member 142C-2 of the pressing switch 142 are formed as separate components, but the first restoring member 142C-1 and the second restoring member 142C-2 may be formed integrally.

Although an embodiment of the present invention is described in detail above, the present invention is not limited to the embodiment, and various modifications or changes are possible within the scope of the gist of the present invention as described in the claims.

What is claimed is:

1. An input device comprising:
a knob configured to receive an operating force from an operator and make a transition by the operating force;
a substrate;
at least one pressing switch provided on one side of the substrate;
a sheet-like rubber member covering the substrate and the pressing switch; and
an actuator member provided between the knob and the rubber member, the actuator member being configured to slide in a first direction perpendicular to the substrate in response to the transition of the knob,
wherein a pre-tension is applied among the knob, the actuator member, and the pressing switch in a neutral state of the input device in which no operating force is applied to the knob,
wherein the pressing switch includes:
a first contact portion having a planar shape and in contact with the rubber member; and
a metal restoring member which elastically biases the first contact portion against the rubber member,
and wherein the actuator member includes:
a second contact portion having a planar shape and facing the first contact portion via the rubber member interposed therebetween, the second contact portion being is in contact with the rubber members; and
at least one protrusion extending from the second contact portion toward the rubber member thereby pressing the rubber member to elastically deforms in the neutral state .

2. The input device according to claim 1, wherein the rubber member includes:
a base portion in contact with the substrates;
a plate-like first portion with a predetermined thickness at least a portion of which is disposed between the first contact portion and the second contact portion, the first portion being pressed by the protrusion so as to deform in the first direction thereby biasing the actuator member in a restoring direction with an elastic restoring force caused by the elastic deformations and
a flexible second portion connecting the base portion and the first portion, the second portion having a thickness smaller than the first portion.

3. The input device according to claim 2,
wherein the substrate has a wiring region on the one side thereof, in which the pressing switch is provided,
and wherein the rubber member covers the entire wiring region in a plan view from the first direction .

4. The input device according to claim 2,
wherein the first contact portion of the pressing switch is disposed within the second contact portion of the actuator in a plan view from the first direction,
and wherein the second contact portion of the actuator is smaller than the first portion of the rubber member and disposed within the first portion in the plan view, the second contact portion including:
a first region overlapping and opposing the first contact portion via the rubber member in the first direction;and
a second region located outside the first region in the plan view and not opposing the first contact portion via the rubber member in the first direction the at least one protrusion being disposed in the second region in the plan view.

5. The input device according to claim 1, further comprising:
a housing including a first guide portion for guiding the actuator member to slide therealong,
wherein the actuator member includes a second guide portion in contact with the first guide portion, the second guide portion having a column shape having a center axis extending in the first direction from one side of the second contact portion,
and wherein the at least one protrusion includes at least three protrusions disposed along a circumference of a circle centered on the center axis in a plan view from the first direction.

6. The input device according to claim 1,
wherein the pressing switch includes a stem member having the first contact portion formed on one side thereof which is closer to the actuator member, the stem member sliding to press the restoring member when the actuator member slides in the first direction and applies an operating load on the stem member.

7. The input device according to claim 6,
wherein a first distance from a distal end of the protrusion to the second contact portion is smaller than a second distance which is a total stroke of the restoring member, the distal end being a tip of the protrusion farthest from the second contact portion.

8. The input device according to claim 7,
wherein the restoring member includes:
a first restoring member configured to reverse when the operating load exceeds a first maximum value; and
a second restoring member configured to reverse when the operating load exceeds a second maximum value after the first restoring member reverses.

9. The input device according to claim 1, wherein a distal end of the protrusion farthest from the second contact portion has a curved surface.

10. The input device according to claim 1, wherein the protrusion has a conical shape that tapers toward a distal end thereof which is farthest from the second contact portion, from the second contact portion.

11. The input device according to claim 1,
wherein the at least one pressing switch includes a pair of pressing switches,
wherein the input device further comprises a shaft portion provided between the pair of pressing switches,
and wherein the knob is rotatably supported by the shaft and subjected to a respective biasing force from a pair of restoring members of the pair of pressing switches.

12. The input device according to claim 11, wherein the pair of pressing switches are covered by the single rubber member.

13. The input device according to claim 8,
wherein the first restoring member completes reversing when a sliding distance of the stem member from the neutral state reaches a third distance after the operating load exceeds the first maximum value,
wherein the second restoring member completes reversing when the sliding distance reaches the second distance after the operating load exceeds the second maximum value,
and wherein the first distance is smaller than the third distance.

14. The input device according to claim 8,
wherein the operating load on the stem member at the third distance is smaller than the first maximum value, and the operating load on the stem member at the second distance is smaller than the second maximum value.
